(19) United States
(12) Patent Application Publication
(10) Pub. No.: US 2007/0010593 A1
(43) Pub. Date: Jan. 11, 2007

(54) Pur-polyester flexible foams based on polyetheresterpolyols

(75) Inventors: Hartmut Nefzger, Pulheim (DE); Bert Klesczewski, Dusseldorf (DE); Eva Pischedda, Dormagen (DE); Manduela Otten, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/480,594

(22) Filed: Jul. 3, 2006

(30) Foreign Application Priority Data
Jul. 8, 2005 (DE) 102005031975.0

(51) Int. Cl. C08G 18/00

(52) U.S. Cl. 521/172

(57) ABSTRACT

The present invention relates to polyetheresterpolyols which have a hydroxyl number of from 60 to 160 and a viscosity of ≦500 mPas at 75° C. These polyetheresterpolyols contain repeat units derived from I) aliphatic polycarboxylic acids, II) polyols having a hydroxyl number greater than 550 mg KOH/g, and III) polyols containing ether groups and having a hydroxyl number less than 120 mg KOH/g. This invention also relates to a process for the preparation of these polyetheresterpolyols, to a mixture containing the polyetheresterpolyols of the invention, to a process for the preparation of this mixture, to a process for the production of a PUR-polyester flexible foam from the mixture containing the polyetheresterpolyols of the invention, to the PUR-polyester flexible foam, to a process for the production of textile/foam and/or print/foam composites containing the PUR-polyester flexible foam, and to the textile/foam and/or print/foam

### CROSS-REFERENCE TO RELATED PATENT APPLICATION

The present patent application claims the right of priority under 35 U.S.C. §119 (a)-(d) of German Patent Application No. 10 2005031975, filed Jul. 8, 2005.

### BACKGROUND OF THE INVENTION

The present invention relates to polyetheresterpolyols, to processes for their preparation, to mixtures containing the polyetheresterpolyols of the invention, to processes for the preparation of such mixtures, to processes for the production of PUR-polyester flexible foams from mixtures containing polyetheresterpolyols of the invention, to PUR-polyester flexible foams, and to processes for the production of textile/foam and/or print/foam composites containing such PUR-polyester flexible foams, and to the textile/foam and/or print/foam composites obtainable by this process.

Polyesterpolyol-based foams are subdivided into conventional foams, textile foams and semi-rigid foams, with the properties of the foam produced being extensively determined by the chemical structure of the polyesterpolyol from which it is prepared. Polyesterpolyols are prepared according to the state of the art by the polycondensation of predominantly bifunctional, short-chain polyols, having hydroxyl numbers of more than 750 mg KOH/g, with predominantly bifunctional polycarboxylic acids. However, through the concomitant use of small proportions of trifunctional structural units, usually on the polyol side, the polyesterpolyols used predominantly have number-average functionalities of between 2 and 3, as described in Polyurethane Handbook, Gunter Oertel (Editor), 2^{nd} ed. 1993, Hanser Publishers, Munich, Vienna, N.Y., p. 201.

One disadvantage of polyesterpolyols compared with polyetherpolyols in terms of their processing is their much higher viscosity.

Polyester-based flexible foams are, nevertheless, used in certain applications. This is the case particularly in the fields where the foam is bonded to other materials by a flame lamination process. A typical application of this type, is the production of roof linings in the automotive sector, where the PUR-polyester flexible foam is heated to melt the surface and, while in this state, a textile is pressed onto the melted surface, and the foam is adhesively bonded thereto. This process is not possible with pure polyether-based foams, as already described in EP-A1 1 108 736.

High structural demands are made on a polyester flexible foam which are used in the automotive sector. Thus, PUR-polyester flexible foams used in this sector should not have any voids, because such defects would be visible on the surface and the material would therefore, be of inferior quality and unusable.

Furthermore, these polyester-based flexible foams which are suitable for flame lamination have to pass the fire test according to FMVSS 302, as prescribed for automotive applications. This can be done, for example, using the flameproofing agents which are liquid at room temperature that are known to those skilled in the art. Such flameproofing agents are chloroalkyl phosphates or phosphites or mixtures thereof such as, for example, tris(2-chloropropyl) phosphate.

However, a disadvantage of such flameproofing agents is that they cause the undesirable release of an off-gas during the flame lamination process. Thus, it is necessary for the off-gas to be exhausted by means of comparatively expensive technical devices because some of its constituents are toxic.

Far less problematic in this respect, are solid halogen-free and organophosphorus-free flameproofing agents such as the inorganic ammonium polyphosphate. However, a polyesterpolyol enriched with a solid flameproofing agent has the disadvantage that the viscosity is markedly increased, so that the processing of polyesterpolyols, which is already more difficult than the processing of polyetherpolyols, is made even more difficult.

An apparently obvious way to resolve this situation, is to use polyetherpolyols to obtain lower-viscosity and hence, more easily pumpable formulations that also allow a higher solids content. For example, polyesterpolyols with viscosity values above 8000 mPas (at 25° C.) are unsuitable in this respect. However, polyester-based flexible foams containing only small proportions of polyether also exhibit substantial disadvantages in-foam formation, because these polyethers are immiscible with the polyesters, as described in Polyurethane Handbook, Günter Oertel (Editor), 2^{nd} ed. 1993, Hanser Publishers, Munich, Vienna, N.Y., p. 201.

EP-A 1 035 687 describes the use of solutions prepared by the reaction of diisocyanates with diprimary diols of a particular structure in higher-molecular weight polyetherpolyols having predominantly secondary hydroxyl groups. However, foams produced in this way are deficient in their ageing resistance, exhibiting only poor recovery capacities after permanent stress.

EP-A1 025 549 describes adding a composition of hydroxypivalic acid neopentyl glycol ester to polyethers in order to achieve a good laminability and an improved high frequency weldability. However, a disadvantage of the foams obtained from these compositions is the increased compression set, which results in an undesirable permanent deformation following mechanical stress.

In U.S. Pat. No. 5,891,928 and U.S. Pat. No. 5,900,087, compositions of polyethers with aliphatic diols or polymeric diols are described which are disclosed as being suitable as polyol formulations for an improved flame laminability. A disadvantage of these systems is the low peel strengths of the resulting polyether foams compared with polyester foams.

EP-A 1 108 736 describes that at least bifunctional, low-molecular aromatic polyols must be added to polyethers as a flame lamination additive. The additive can consist either of aromatic polyesterpolyols or of aromatic polyetherpolyols. The polyesterpolyols that can be used are obtained from phthalic acid, terephthalic acid, isophthalic acid, trimellitic acid and trimesic acid with glycols such as ethylene glycol and propylene glycol. These aromatic polyesterpolyols have molecular weights ranging from 150 to 1200 Da, and preferably from 150 to 1000 Da. However, such polyols which contain flame lamination additives have several disadvantages. For example, the increased viscosity due to the flame lamination additive, whereby the flame laminability does not fully reach the level of polyester-based materials. These disadvantages can only be partially overcome by increasing the expenditure on technology, e.g. with separate metering using more powerful pumping systems.

Thus, an object of the present invention was to provide polyetheresterpolyols that afford mixtures which, at room temperature and the processing temperature, are miscible and pumpable, and have markedly lower viscosities than pure polyester-polyols, so that these mixtures can be used to produce PUR flexible foams suitable for flame lamination whose property profile corresponds to that of the state of the art.

### SUMMARY OF THE INVENTION

This object is achieved by polyetheresterpolyols having a hydroxyl number ranging from 60 to 160 mg KOH/g, and a viscosity of ≦500 mPas at 75° C., and containing repeat units derived from:
I) one or more aliphatic polycarboxylic acids,
II) one or more polyols having a hydroxyl number greater than 550 mg KOH/g, and
III) one or more polyols containing ether groups and having a hydroxyl number less than 120 mg KOH/g.

The group II) polyols of the polyetheresterpolyols according to the invention are advantageously selected from the group consisting of (i) aliphatic diols containing αω-terminal hydroxyl groups, and (ii) polyols having a hydroxyl functionality greater than 2.

The group III) polyols of the polyetheresterpolyols according to the invention advantageously have an ethylene oxide content of 30 to 85 wt. % and a functionality of 1.8 to 3.5.

The hydroxyl number of the polyetheresterpolyols according to the invention preferably ranges from 80 to 125 mg KOH/g.

The polyetheresterpolyols according to the invention are advantageously miscible in amounts of at least 5 wt. %, with poly(diethylene glycol) adipate at room temperature.

The present invention also provides a process for the preparation of the polyetheresterpolyols as described above, comprising polycondensing the components of groups I), II) and III), with the elimination of water or a monofunctional C₁-C₄ alcohol.

The process for the preparation of the polyetheresterpolyols according to the invention is advantageous when the polycondensation proceeds at pressures ranging from less than 50 mbar to normal pressure, and at temperatures above 150° C.

A preferred process for the preparation of the polyetheresterpolyols according to the invention comprises (1) combining all the components of groups I), II) and III) together at the same time, (2) condensing the combined components under normal pressure, using an inert gas, at a temperature ranging from 120 to 220° C., and particularly preferably from 170 to 205° C., until no more water of reaction distills off, (3) optionally, adding an esterification catalyst, (4) reducing the pressure to less than 50 mbar over 2 to 6 hours, and (5) polyconsdensing the reaction mixture, at a temperature ranging from 180 to 220° C., under a full water-jet vacuum, until the acid number of the resultant product is less than 1.5 mg KOH/g.

The present invention also provides mixtures that are clear at room temperature. These mixture contain (a) ≧50 parts by weight of poly(diethylene glycol) adipate, and (b) ≦50 parts by weight of one or more polyetheresterpolyols according to the invention.

The invention also provides a process for the preparation of these mixtures. This process comprises (1) mixing the poly(diethylene glycol) adipate, with one or more of the polyetheresterpolyols according to the invention.

The invention also provides a process for the production of a PUR-polyester flexible foam comprising the following steps: reacting
a) the mixture containing one or more polyetheresterpolyols according to the invention and a poly(diethylene glycol) adipate, with
b) a polyisocyanate component, in the presence of
c) a blowing agent,
d) one or more catalysts, and
e) optionally, one or more flameproofing agents and/or other auxiliary substances and additives.

This invention also provides a PUR-polyester flexible foam obtainable by the process using the mixture containing polyetheresterpolyols according to the invention.

The present invention also provides a process for the production of a composite, comprising laminating the PUR-polyester flexible foam produced by the above process from the mixture containing polyetheresterpolyols of the invention, with a textile or a covering layer. This lamination process can be achieved by means of a surface melting process or a suitable adhesion process. The invention also provides the textile/foam composites (i.e. laminates) produced by this process. In conventional processing, these laminates can be produced by bringing together the melted layer of foam and the textile covering layer. This is accomplished by, briefly flaming the polyurethane foams used in processes according to the invention, and then bonding the flamed surface to a textile made of polyamide, polyester, cotton or leather derivatives, to give a permanently high peel strength. The conventional procedure is to apply a Charmeuse fabric to the foam. Another method of producing the laminates according to the invention is to bond the foams to the textile covering layer with hot-melt adhesives by means of the hot-melt adhesive bonding technique known per se.

The invention also provides a textile/foam composite and/or a covering layer/foam composite which contain PUR-polyester flexible foam. These are produced by the process of the invention, using the mixture containing polyetheresterpolyols described herein.

### DETAILED DESCRIPTION OF THE INVENTION

The polyetheresterpolyols of the invention are characterized in that they are comprised of three main structural components: I) one or more aliphatic polycarboxylic acids, II) one or more polyols having a hydroxyl number greater than 550 mg KOH/g, and III) one or more polyols containing ether groups and having a hydroxyl number less than 120 mg KOH/g.

The aliphatic polycarboxylic acids suitable to be used as components I) of the polyetheresterpolyols are selected from the group consisting of: succinic acid, glutaric acid, adipic acid, mixtures of these acids, mixtures of the anhydrides of these acids, and esters of these acids with monofunctional C₁-C₄ alcohols. The alcohols which are preferably suitable for the preparation of the esters of these aliphatic polycarboxylic acids are selected from the group consisting of: methanol, ethanol, 1-propanol, isopropanol, 1-butanol, 2-butanol and tert-butanol. More preferred acids suitable herein include the aliphatic polycarboxylic acids which are selected from the group consisting of succinic acid, glutaric acid and adipic acid. Adipic acid is particularly preferred as component I).

The one or more polyols suitable as group II) component include those polyols having a hydroxyl number greater than 550 mg KOH/g. These polyols are selected from the group consisting of (i) unbranched aliphatic diols containing α,ω-terminal hydroxyl groups, which can optionally contain up to three ether groups, and (ii) polyols having a hydroxyl functionality greater than 2. Preferred polyols to be used as component II) polyols are 1,2-ethylene glycol, 1,3-propylene glycol, 1,4-butylene glycol, 1,6-hexylene glycol, diethylene glycol, triethylene glycol and tetraethylene glycol. Diethylene glycol is particularly preferred. Preferred polyols which have a hydroxyl functionality greater than 2 are selected from the group consisting of 1,1,1-trimethylolpropane, pentaerythritol and glycerol.

The polyols suitable to be used as component III) are those polyols containing ether groups and having a hydroxyl number less than 120 mg KOH/g. Such polyols include, for example, polyetherpolyols prepared from ethylene oxide and/or propylene oxide by ring-opening polymerization. It is, of course, possible here to use both the base-catalysed variants and the types prepared using two-metal catalysis. Examples of suitable starters for these polyetherpolyols include bifunctional and trifunctional diols, mixtures thereof, and water. Polyetherpolyols suitable as component III) also include copolyethers, characterized in that more than one aliphatic epoxide polymerizable by ring-opening polymerization can be used, with both block and random incorporation of the epoxides being included. The preferred copolyethers are those prepared using ethylene oxide and propylene oxide in a predominantly block arrangement, with propylene oxide preferably being used first, and then ethylene oxide. The polyols used as component III) preferably have ethylene oxide contents of 33 to 85 wt. %, and also functionalities of 1.80 to 3.5, preferably of 1.90 to 3.0. It is, of course, also possible to use mixtures of more than one polyetherpolyol as the component III) herein.

The polyetheresterpolyols are preferably prepared by polycondensation with the elimination of water, or optionally with the elimination of a monofunctional C₁-C₄ alcohol. This reaction takes place initially at normal pressure, subsequently at reduced pressure, and finally at pressures below 50 mbar, and at temperatures above 150° C., and preferably between 170° C. and 250° C. The polycondensation reaction can be carried out with or without catalysis. A typical representative catalyst which may be mentioned for the water-eliminating polycondensation is tin dichloride. Of course, this reaction can also be carried out with the aid of an entraining agent such as, for example, toluene, xylene or dioxane, but the reaction is preferably carried out in bulk. The polyetheresterpolyols can of course be prepared using one or more esterification or transesterification catalysts known to those skilled in the art.

In a preferred embodiment, all the reaction components (i.e. components I), II) and III) are combined together at the same time, and initially heated at normal pressure, without catalysis, in the presence of an inert gas, to a reaction temperature ranging from 120° C. to 220° C., and more preferably from 170° C. to 205° C., with the elimination of water. After this normal pressure phase, and optionally, after the addition of an esterification catalyst, the pressure is reduced over 2 to 6 hours to below 50 mbar, and finally to a full water-jet vacuum, and the reaction is taken to completion, i.e. until the acid number of the resultant product is below 1.5 mg KOH/g.

Alternatively, the polyetheresterpolyols of the invention can also be prepared by the nitrogen blowing process, wherein the condensate is driven out of the reaction vessel by a stream of nitrogen. This process is described in J. H. Saunders and K. C. Frisch in Polyurethanes: Chemistry and Technology, Part I. Chemistry, Interscience Publishers John Wiley & Sons, New York 1962, p. 45.

The molecular weight of the resultant polyetheresterpolyols is controlled here by choosing a substoichiometric amount of component I) which contains carboxyl groups as compared to components II) and III) which both contain hydroxyl groups. This results in the polyetheresterpolyols of the invention having hydroxyl numbers of 60 to 160 mg KOH/g, and preferably of 80 to 125 mg KOH/g.

The polyetheresterpolyols of the invention are further characterized in that the viscosity as measured at 75° C. does not exceed 500 mPas. In addition, the polyetheresterpolyols so produced are suitable for the production of PUR flexible foams, provided that they are miscible, i.e. they form a clear mixture at room temperature, when mixed with a commercially available poly(diethylene glycol) adipate which is also used for the production of polyester flexible foams. More specifically, the mixtures which are clear at room temperature comprise (a) ≧50 parts by weight of poly(diethylene glycol) adipate, and (b) ≦50 parts by weight of one or more polyetheresterpolyols of the present invention as described herein. Particular preference is given to poly(diethylene glycol) adipates such as, for example, that which is commercially available under the name Desmophen® 2200B from Bayer MaterialScience AG, which has a hydroxyl number of 60 mg KOH/g, a viscosity of 1000 mPas (75° C.), and an equivalent weight of 935 g/mol.

In the production of PUR-polyester flexible foams, one or more of the polyetheresterpolyols described herein are mixed with poly(diethylene glycol) adipate. These mixtures comprise (a) 50 to 95 parts by weight of poly(diethylene glycol) adipate, and (b) 5 to 50 parts by weight of one or more polyetheresterpolyols described herein. A preferred ratio is 5 to 30 parts by weight of polyetheresterpolyols according to the invention and 70 to 95 parts by weight of poly(diethylene glycol) adipate.

These mixtures can then be used for the production of a PUR-polyester flexible foam. In the process for producing a PUR-polyester flexible foam, the above mixtures are reacted with a polyisocyanate component.

Suitable polyisocyanate components to be used in the production of PUR-polyester flexible foams are understood as including organic diisocyanates or polyisocyanates or polyisocyanate prepolymers. Suitable diisocyanates or poly-isocyanates are aliphatic, cycloaliphatic, araliphatic, aromatic and heterocyclic polyisocyanates, such as those described in Justus Liebigs Annalen der Chemie 562, (1949) 75, for example those of the formula
Q(NCO)ₙ
in which
n represents an integer from 2 to 4, preferably 2,
and
Q represents an aliphatic hydrocarbon radical having 2 to 18 carbon atoms, preferably 6 to 10 carbon atoms; a cycloaliphatic hydrocarbon radical having 4 to 15 carbon atoms, preferably 5 to 10 carbon atoms; an aromatic hydrocarbon radical having 6 to 15 carbon atoms, preferably 6 to 13 carbon atoms, or an araliphatic hydrocarbon radical having 8 to 15 carbon atoms, preferably 8 to 13 carbon atoms.

Preference are polyisocyanates such as those described in DE-OS 28 32 253, which is believed to correspond to U.S. Pat. No. 4,263,408, the disclosure of which is hereby incorporated by reference. It is more preferred, as a rule, to use the polyisocyanates that are readily available to industry such as, for example, 2,4-and 2,6-toluylene diisocyanate and any desired mixtures of these isomers (“TDI”), polyphenylenepolymethylene polyisocyanates, such as those prepared by aniline-formaldehyde condensation and subsequent phosgenation (“crude MDI”), and polyisocyanates containing carbodiimide groups, urethane groups, allophanate groups, isocyanurate groups, urea groups or biuret groups (“modified polyisocyanates”), and more are modified polyisocyanates derived from 2,4-and/or 2,6-toluylene diisocyanate, or 4,4′- and/or 2,4′-diphenyhnethane diisocyanate. It is also possible to use prepolymers which are prepared by reacting these polyisocyanates with one or more organic compounds containing at least one hydroxyl group. Examples of such organic compounds which contain at least one hydroxyl group include polyols or polyesters containing one to four hydroxyl groups, and having (number-average) molecular weights of 60 to 1400.

It is most preferred to use the polyisocyanates having a functionality greater than 2.0 and which are industrially available under the name “polymeric diphenylmethane diisocyanate”, and prepolymers prepared therefrom.

For the production of the PUR-polyester flexible foam, a blowing agent and a catalyst are also present. These can be added either to the mixture containing the polyetheresterpolyol described herein and the poly(diethylene glycol) adipate, or the polyisocyanate component.

Suitable blowing agents to be used in the production of PUR-polyester flexible foam include those selected from the group consisting of water, carbon dioxide, preferably in liquid form, C₃-C₆ alkanes, halogenated hydrocarbons, carboxylic acids and azo compounds, which release gases during the foaming process. Preferred C₃-C₆ alkanes include butanes, n-pentane, isopentane, cyclopentane and hexanes. Preferred halogenated hydrocarbons include compounds such as dichloromethane, dichloromonofluoromethane, chlorodifluoroethanes, 1,1-dichloro-2,2,2-trifluoroethane, 2,2-dichloro-2-fluoroethane, difluoromethane, trifluoromethane, difluoroethane, 1,1,1,2-tetrafluoroethane, tetrafluoroethane (R134 or R134a), 1,1,1,3,3-pentafluoropropane (R245fa), 1,1,1,3,3,3-hexafluoropropane (R356), 1,1,1,3,3-pentafluorobutane (R365mfc), heptafluoropropane, sulfur hexafluoride or mixtures of these halogenated hydrocarbons. Difluoromethane, trifluoromethane, difluoroethane, 1,1,1,2-tetrafluoroethane, tetrafluoroethane (R134 or R134a), 1,1,1,3,3-pentafluoro-propane (R245fa), 1,1,1,3,3,3-hexafluoropropane (R356), 1,1,1,3,3-pentafluoro-butane (R365mfc), heptafluoropropane and sulfur hexafluoride are most preferred of the halogenated hydrocarbons. These blowing agents are particularly preferably used with water. It is most preferred that water is the blowing agent.

Suitable amine catalysts include the following: N,N′-dimethylpiperazine, piperazine, N-methyl-N′-dimethylaminoethylpiperazine, bis(dimethylamino-diethylaminoethyl) adipate, N-methylmorpholine, triethylamine, tributylamine, N-ethylmorpholine, 1,4-diazabicyclooctane, N,N′-dimethylbenzylamine, N,N′-diethylbenzylamine, N,N-dimethylcyclohexylamine, N,N,N′,N′-tetramethyl-ethylenediamine, pentamethyldiethylenetriamine and higher homologues, monocyclic and bicyclic amidines such as bis(dialkylaminoalkyl) ethers, e.g. 2,2′-bis(dimethylaminoethyl) ether, 2-methylimidazole, 1,2-dimethylimidazole, N,N-dimethyl-p-phenylethylamine and N,N,N′,N′-tetramethyl-1,3-butanediamine. Other suitable catalysts which containing metal ions include, for example, the following compounds, tin(II) ethylhexanoate, dibutyltin dilaurate, dibutyltin diacetate, dibutyltin maleate, dioctyltin diacetate, dibutyltin dichloride, tin(II) acetate, tin(II) octanoate, tin(II) laureate and di-n-octyltin mercaptide.

Other flameproofing agents as well as auxiliary substances and additives can also be used in the production of the PUR-polyester flexible foams. Examples of flameproofing agents include ammonium polyphosphate, tricresyl phosphate, tris(2-chloroethyl) phosphate, tris(2-chloropropyl) phosphate, tris(2,3-dibromo-propyl) phosphate, tetrakis(2-chloroethyl)ethyl diphosphate, dimethyl methane-phosphonate, diethyl diethanolaminomethylphosphonate, tris(dipropylene glycol) phosphite, tris(dipropylene glycol) phosphate, bis(2-hydroxyethyl)ethylene glycol diphosphate bis(2-chloroethyl) ester, and halogen-containing polyols with flameproofing activity. Other examples of auxiliary substances and additives that may also be used include foam stabilizers, cell regulators, reaction retarders, stabilizers, plasticizers, colorants, fillers, and substances having flingistatic and/or bacteriostatic activity. These are usually added to the mixture according to the invention, which comprises one or more of the polyetheresterpolyols described herein and the poly(diethylene glycol) adipate, in amounts of 0 to 10 parts by weight, and preferably of 2 to 6 parts by weight. Details of the mode of use and mode of action of these auxiliary substances and additives are described in G. Oertel (ed.): “Kunststoff-Handbuch”, volume VII, Carl Hanser Verlag, 3rd edition, Munich 1993, pp 110-115.

The polyester foams are conventionally produced by intimately mixing, in mechanical devices, the mixture containing the one or more polyetheresterpolyols described herein and the poly(diethylene glycol) adipate with the blowing agent, catalyst, and optionally, any flameproofing agent, auxiliary substances and/or additives. The foams can be produced either continuously, for instance on a conveyor belt system, or batchwise. The production of flexible foams is known to those skilled in the art and is described e.g. in G. Oertel (ed.): “Kunststoff-Handbuch”, volume VII, Carl Hanser Verlag, 3rd edition, Munich 1993, pp 193-220.

The present invention also provides textile/foam composites (laminates) which are produced from the foams of the invention. In conventional processing, these laminates can be produced, for example, by bringing together the melted layer of foam with the textile covering layer. Thus, such a process typically requires flaming of the polyetherpolyurethane foams as described herein, and then bonding the melted foam to a textile that is made of polyamide, polyester, cotton or leather derivatives to give a permanently high peel strength. The conventional procedure applies a Charmeuse fabric to the foam. Another method of producing the laminates of the invention comprises bonding of the foam produced from the polyetheresterpolyol of the invention, to the textile covering layer with hot-melt adhesives. This is typically by means of the hot-melt adhesive bonding technique which known per se, or by means of dispersion adhesives.

The invention is further illustrated but is not intended to be limited by the following examples in which all parts and percentages are by weight unless otherwise specified.

### EXAMPLES

Description of the Raw Materials Used:

I) Aliphatic Polycarboxylic Acids:
(1) Adipic acid, technical grade
(2) Sebacic acid, technical grade
(3) Pripol® 1006: a commercial product from Uniqema which is a dimeric fatty acid with an acid number of 194-198 mg KOH/g

II) Polyols with Hydroxyl Number Hreater than 550 mg KOH/g:
(1) Diethylene glycol, technical grade
(2) 1,1,1-Trimethylolpropane, technical grade (TMP)

III) Polyols Containing Ether Groups with a Hydroxyl Number Less than 120 mg KOH/g:

The polyethers are shown in Table 1.

TABLE 1
Properties of the polyetherpolyols used

| | OH number | functionality | EO content % |
|---|---|---|---|
| Polyether 1 | 57 | 2 | 50 |
| Polyether 2 | 37 | 3 | 72 |
| Polyether 3 | 28 | 2 | 30 |

PDEGA: poly(diethylene glycol) adipate

TABLE 2
Formulations for the preparation of polyetheresterpolyols

| | | | | | | | | | OH | | | |
|---|---|---|---|---|---|---|---|---|---|---|---|---|
| | Polyether | Polyether | Polyether | Diethylene | Pripol ® | Adipic | Sebacic | | number | | Visc. at | Visc. at |
| Example | 1 | 2 | 3 | glycol | 1006 | acid | acid | TMP | [mg | | 75° C. | 25° C. |
| ppp | [wt. %] | [wt. %] | [wt. %] | [wt. %] | [wt. %] | [wt. %] | [wt. %] | [wt. %] | KOH/g] | F | [mPas] | [mPas] |
| 1 | | | 72.4 | 16.5 | | 11.1 | | | 109 | 2 | 163 | 1370 |
| 2 | | | 69.9 | 15.9 | | | 14.2 | | 112.6 | 2 | 150 | 1190 |
| 3 | | | 78 | 10 | | 12 | | | 37.6 | 2 | 470 | 4300 |
| 4 | | | 74.9 | 13.1 | | 5 | 7 | | 83.7 | 2 | 190 | 1500 |
| 5 | | | 63.4 | 10.2 | 26.4 | | | | 73.4 | 2 | 250 | 2190 |
| 6 | | | 75.6 | 17.2 | | 7.2 | | | 145.4 | 2 | 122 | 965 |
| 7 | | | 51.1 | 25.6 | | 23.3 | | | 111.8 | 2 | 637 | 6690 |
| 8 | | | 34.6 | 34.6 | | 30.9 | | | 143.4 | 2 | 140 | 1470 |
| 9 | | 33.1 | | 33.1 | | 33.8 | | | 109.3 | 2.08 | 240 | 2440 |
| 10 | 32.8 | | | 32.8 | | 34.4 | | | 111.5 | 2 | 130 | 1250 |
| PDEGA | | | | 41.3 | | 55.4 | | 3.3 | 60 | 2.73 | 1000 | 17,500 |

A criterion for polyetheresterpolyols of the invention which are suitable for the production of PUR flexible foams, is the formation of a clear solution at room temperature from a mixture of ≦50 parts by weight of one or more polyether-esterpolyols of the invention, and ≧50 parts by weight of poly(diethylene glycol) adipate.

The relevant details are given in Table 3:

TABLE 3
Test for compatibility with poly(diethylene glycol)adipate

| | Miscibility with poly(diethylene glycol) adipate | | | | | | | |
|---|---|---|---|---|---|---|---|---|
| | Room temperature | | | | 50° C. | | | |
| | Mixing ratio [parts of polyetheresterpolyol] | | | | | | | |
| Example | 5 | 20 | 50 | 66 | 5 | 20 | 50 | 66 |
| 1 | | | | | | | | |
| 2 | no | no | no | no | no | no | no | no |
| 3 | no | no | no | no | no | no | no | no |
| 4 | no | no | no | no | no | no | no | no |
| 5 | no | no | no | no | no | no | no | no |
| 6 | no | no | | | no | no | | |
| 7 | no | no | | | no | no | | |
| 8 | no | no | | | no | no | | |
| 9 | yes | yes | yes | | yes | yes | yes | |
| 10 | yes | yes | yes | | yes | yes | yes | |

In Table 3, the balance of each mixture is poly(diethylene glycol) adipate. Thus, when 5 parts of the polyetheresterpolyol are used, 95 parts of poly(diethylene glycol) adipate are used; when 20 parts of the polyetheresterpolyol are used, 80 parts of poly(diethylene glycol) adipate are used; when 50 parts of the polyetheresterpolyol are used, 50 parts of poly(diethylene glycol) adipate are used; and when 66 parts of the polyetheresterpolyol are used, 34 parts of poly(diethylene glycol) adipate are used.

It is apparent from Table 3 that only Examples 9 and 10 satisfy the criterion of forming a clear solution at room temperature. Thus, only the polyetheresterpolyols of Examples 9 and 10 from Table 2 are suitable as a polyol component for the production of PUR flexible foams and suitable for flame lamination in accordance with the present invention. The polyetheresterpolyols of Examples 1-8 in Table 2 are not suitable as a polyol component for the production of PUR flexible foams in accordance with the present invention.

Test for suitability of the polyetheresterpolyols for the production of PUR-polyester flexible foams: the formulations as shown in Table 4 were proportioned via a mixing head on a foaming machine (Hennecke UBT).

TABLE 4
Foam formulations and properties

| | | | | | According to the |
|---|---|---|---|---|---|
| Polyester no. from Table 3 | | Comparative Examples | | | invention |
| Poly(diethylene glycol) adipate | [parts] | 80 | 80 | 80 | |
| Polyetheresterpolyol 1 | [parts] | 20 | | | |
| Polyetheresterpolyol 6 | [parts] | | 20 | | |
| Polyetheresterpolyol 7 | [parts] | | | 20 | |
| Polyetheresterpolyol 9 | [parts] | | | | 20 |
| Water | [parts] | 3 | 3 | 3 | 3 |
| Stabilizer 9100¹ | [parts] | 0.8 | 0.8 | 0.8 | 0.8 |
| Catalyst A30² | [parts] | 0.18 | 0.18 | 0.18 | 0.18 |
| Catalyst A117³ | [parts] | 0.18 | 0.18 | 0.18 | 0.18 |
| TDI-65 | [parts] | 19.6 | 19.6 | 19.6 | 19.6 |
| TDI-80 | [parts] | 19.6 | 19.6 | 19.6 | 19.6 |
| Index | [ ] | 98 | 98 | 98 | 98 |
| Mechanical properties: | | collapse | collapse | collapse | |
| Bulk density according to DIN EN ISO 3386-1-98 | [kg m⁻³] | | | | 38.6 |
| Tensile strength according to DIN EN ISO 1798 | [kPa] | | | | 171 |
| Elongation at break according to DIN EN ISO | [%] | | | | 392 |
| 1798 | | | | | |
| Compression hardness at 40% according to DIN | [kPa] | | | | 3.4 |
| EN ISO 3386-1-98 | | | | | |
| Compression set (50%) according to DIN EN ISO | [%] | | | | 2.8 |
| 1856-2000 | | | | | |
| MVSS according to ISO 3795 (self-extinguishing?) | | | | | yes |
| Voids | | | | | void-free |

¹Stabilizer 9100: Silbyk 9100 from Byk Chemie
²Catalyst A30: Amine catalyst A30 from Rheinchemie
³Catalyst A117: Amine catalyst A117 from Rheinchemie

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Polyetheresterpolyols having a hydroxyl number ranging from 60 to 160 mg KOH/g, a viscosity of ≦500 mPas at 75° C. and which contain repeat units derived from:
I) one or more aliphatic polycarboxylic acids,
II) one or more polyols having a hydroxyl number greater than 550 mg KOH/g,
and
III) one or more polyols containing ether groups and having a hydroxyl number less than 120 mg KOH/g.

2. The polyetheresterpolyols of claim 1, wherein II) said one or more polyols are selected from the group consisting of (i) aliphatic diols containing α,ω-terminal hydroxyl groups, and (ii) polyols having a hydroxyl functionality greater than 2.

3. The polyetheresterpolyols of claim 1, wherein II) said one or more polyols have an ethylene oxide content of 30 to 85 wt. % and a functionality of 1.8 to 3.5.

4. The polyetheresterpolyols of claim 1, wherein the hydroxyl number of the polyetheresterpolyol ranges from 80 to 125 mg KOH/g.

5. The polyetheresterpolyols of claim 1, which are miscible in amounts of at least 5 wt. % with poly(diethylene glycol) adipate at room temperature.

6. A process for the preparation of the polyetheresterpolyols of claim 1, comprising polycondensing the components of groups I, II and III with the elimination of water or a monofunctional C₁-C₄ alcohol.

7. The process of claim 6, wherein the polycondensation proceeds at pressures ranging from less than 50 mbar to normal pressure and at temperatures above 150° C.

8. The process of claim 6, comprising
(1) combining all the components of groups I), II) and III) together,
(2) condensing the combined components from (1) under normal pressure, using an inert gas, at a temperature ranging from 120 to 220° C., until no more water of reaction distills off,
(3) optionally, adding an esterification catalyst,
(4) reducing the pressure to less than 50 mbar over 2 to 6 hours,
and
(5) polycondensing the reaction mixture at temperatures ranging from 180 to 220° C., under a full waterjet vacuum, until the acid number is less than 1.5 mg KOH/g.

9. The process of claim 8, wherein (2) said condensation is at a temperature ranging from 170 to 205° C.

10. A mixture which is clear at room temperature and comprises ≧50 parts by weight of poly(diethylene glycol) adipate, and ≦50 parts by weight of the polyetheresterpolyols of claim 1.

11. A process for the preparation of the mixture of claim 10, comprising
(1) mixing
(a) ≧50 parts by weight of poly(diethylene glycol) adipate
with
(b) ≦50 parts by weight one or more polyetheresterpolyols having a hydroxyl number ranging from 60 to 160 mg KOH/g, a viscosity of ≦500 mPas at 75° C. and which contain repeat units derived from:
I) one or more aliphatic polycarboxylic acids,
II) one or more polyols having a hydroxyl number greater than 550 mg KOH/g,
and
III) one or more polyols containing ether groups and having a hydroxyl number less than 120 mg KOH/g.

12. A process for the production of a PUR-polyester flexible foam comprising reacting:
A) the mixture according to claim 10,
with
B) a polyisocyanate component,
in the presence of
C) a blowing agent,
D) one or more catalysts,
and
E) optionally, one or more flameproofing agents and/or other auxiliary substances and additives.

13. A PUR-polyester flexible foam produced by the process of claim 12.

14. A process for the production of a composite, comprising
(1) laminating the PUR-polyester flexible foam produced by the process of claim 12 with a textile or a covering layer.

15. The process of claim 14, wherein the lamination is achieved by melting the surface of the PUR-polyester flexible foam and contacting the melted surface with the textile or covering layer.

16. The process of claim 14, wherein the lamination is achieved by applying an adhesive or one or both the PUR-polyester flexible foam and/or the textile or covering layer, and contacting the two layers with the adhesive between the layers.

17. A composite comprising a textile/foam or a cover layer/foam, which is produced by the process of claim 14, wherein-the foam comprises the reaction product of:
A) a mixture comprising
(a) ≧50 parts by weight of poly(diethylene glycol) adipate,
and
(b) ≦50 parts by weight one or more polyetheresterpolyols having a hydroxyl number ranging from 60 to 160 mg KOH/g, a viscosity of ≦500 mPas at 75° C. and which contain repeat units derived from:
I) one or more aliphatic polycarboxylic acids,
II) one or more polyols having a hydroxyl number greater than 550 mg KOH/g,
and
III) one or more polyols containing ether groups and having a hydroxyl number less than 120 mg KOH/g;
with
B) a polyisocyanate component,
in the presence of
C) a blowing agent,
D) one or more catalysts,
and
E) optionally, one or more flameproofing agents and/or other auxiliary substances and additives.
